(19) United States
(12) Patent Application Publication
(10) Pub. No.: US 2002/0098893 A1
(43) Pub. Date: Jul. 25, 2002

(54) Torsion vibration damper

(76) Inventor: Ulrich Rohs, Duren (DE)

Correspondence Address: Steven J. Hultquist, Intellectual Property /Technology Law, P.O. Box 14329, Research Triangle Park, NC, 27709, US

(21) Appl. No.: 09/769,994

(22) Filed: Jan. 25, 2001

(30) Foreign Application Priority Data
Jan. 19, 2001 (DE) 201 01 059.3

(51) Int. Cl. F16D 3/12; F16D 3/14; F16D 3/66

(52) U.S. Cl. 464/61

(57) ABSTRACT

A torsion vibration damper with two modules mounted on bearings and capable of rotational movement in relation to one another, in which at least one module features a toothed wheel comprising a toothed rim. The toothed rim is designed to be wider than is the case with conventional toothed rims of the prior art. In this way, an additional mass, which must otherwise be secured to the torsion vibration damper in the form of an additional module, can be applied inherently by means of the toothed rim.

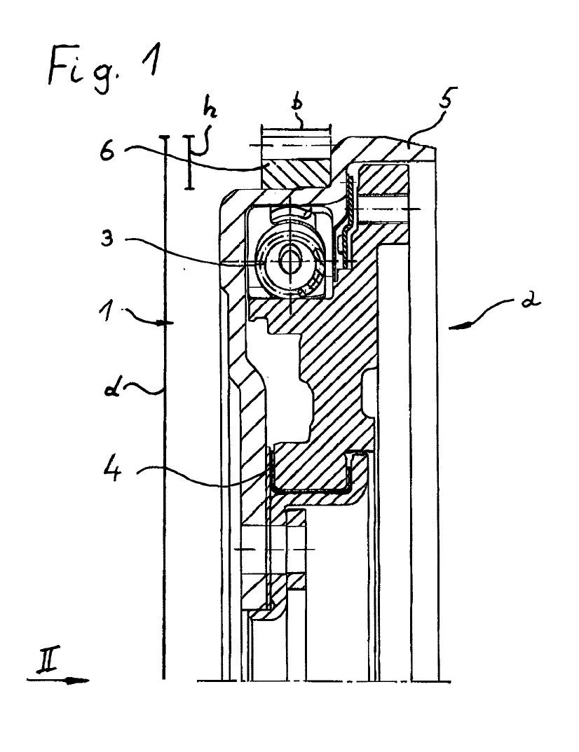

The invention relates to a torsion vibration damper with two modules mounted on bearings such as to be capable of rotational movement in relation to one another, in which at least one module features a toothed rim. A torsion vibration damper of this type is known, for example, from DE 198 17 905 A1, in particular from FIG. 1 thereof. In this situation, the torsion vibration damper comprises two modules, each of which features its own moment of inertias and which are mounted so as to be capable of rotational movement in respect of one another by means of a spring arrangement. In addition to this, devices are provided for with the torsion vibration damper which disperse friction and energy, so that, at a relative movement of the two modules in relation to one another, a vibration damping effect is achieved.

Torsion vibration dampers of this kind are used, inter alia, in motor vehicles, in particular if they feature an internal combustion engine. In such application instances in particular, a toothed rim is provided for on one of the modules, which is capable of meshing with a pinion of a starter motor, in order in this way to introduce the necessary energy to start the engine into the drive train of the vehicle.

In order to provide the necessary torque to the module which features the starter toothed rim, which is usually designated as the primary mass, this module features an additional mass located radially on the exterior, by means of which the moment of inertia of this module can be adapted to the conditions specified by the motor vehicle manufacturers.

The objective of the present invention is to provide a torsion vibration damper which is significantly simpler to construct that the known torsion vibration dampers.

As a solution, the invention proposes forming the toothed rim and the additional mass in the form of one single module. By means of this inventive basic idea, the number of modules necessary for the torsion vibration damper can be reduced, so that this torsion vibration damper can be manufactured substantially more economically. This is achieved on the one hand by reducing the number of components and, on the other, by reducing the expenditure and effort required for assembly.

In a specific implementation, the invention accordingly proposes, on the one hand, a torsion vibration damper with two modules mounted on bearings and capable of rotational movement in relation to one another, in which at least one module features a toothed rim, which is designed to be wider than 12 mm, for preference, the toothed rim is designed to be wider than 13 mm and wider than 14 mm respectively. The invention is manifested particularly clearly if the toothed rim is designed to be wider than 15 mm or wider than 16 mm respectively, and, in particular, wider than 17 mm.

In addition to this, the invention proposes a torsion vibration damper with two modules mounted on bearings and capable of rotational movement in relation to one another, in which at least one module features a toothed wheel, of which the ratio of the wheel width to the wheel height is greater than 1, or greater than 1.1, and in particular greater than 1.2.

As a further solution the invention proposes a torsion vibration damper for two modules mounted on bearings and capable of rotational movement in relation to one another, in which at least one module features a toothed wheel, of which the ratio of the toothed wheel width to the toothed wheel diameter is greater than 0.05 and greater than 0.052 respectively. In this respect the invention is manifested particularly clearly if this ratio is greater thin 0.053 or greater than 0.055 and in particularly greater than 0.058 respectively.

To this extent, starting from the inventive basic idea, it is determinant, according to the invention, that the toothed rim be designed wider or stronger than is the case with conventional toothed rims of the prior art. In this way, the mass, which must otherwise be secured to the torsion vibration damper in the form of an additional module, can be applied inherently by means of the toothed rim and it is therefore possible to achieve the inventive advantages.

The geometrical scales indicated heretofore relate for preference to torsion vibration dampers which are used in a motor vehicle with a displacement of less than 3 liters. With torsion vibration dampers of this kind, the toothed rims are designed to be relatively narrow, so that, as a rule, an additional mass is required in order to provide the moment of inertia required.

An additional expenditure of effort due to a wider toothed rim, which may be involved with preparing the teeth off the toothed rim, is insubstantial in relationship to the reduction of the installation effort and the number of modules, since it does not incur any increase in costs worth mentioning. In addition to this, the broadening of the toothed rim in relation to conventional toothed rims has the advantage that a vibration damper according to the invention features a greater installation tolerance with regard to the pinion for the starter motor or similar modules, so that the size of this pinion in relation to known starter pinions, which are normally chosen to be relatively wide in order to guarantee adequate installation tolerance can be selected as substantially smaller. This allows for costs to be reduced still further.

Further advantages, aims, and properties of the present invention are explained on the basis of the drawing appended to the description, in which, for example, a torsion vibration damper according to the invention is represented.

The drawings show:

FIG. 1A section through a torsion vibration damper according to the invention, and

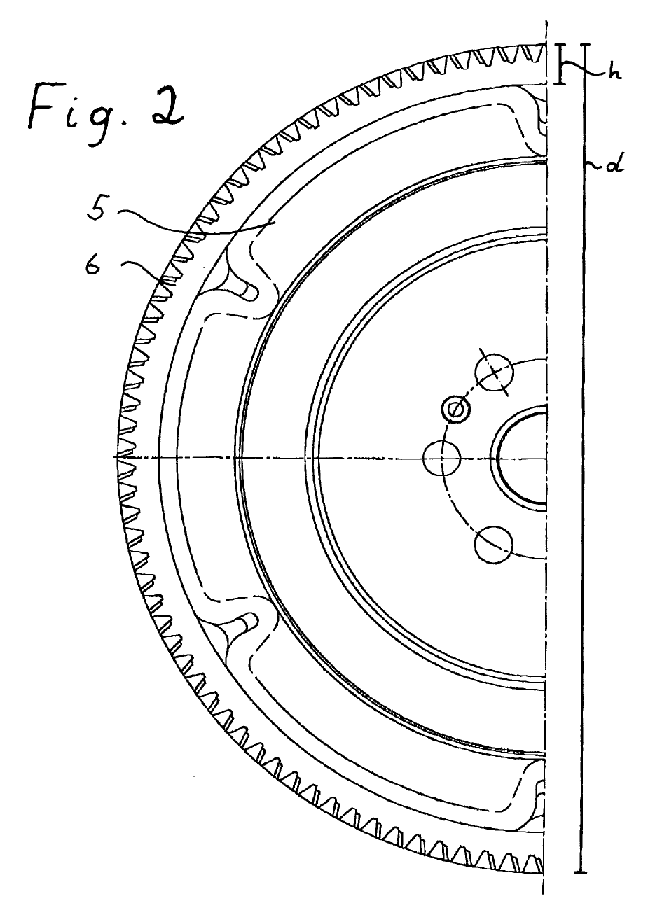

FIG. 2A side view of the torsion vibration damper according to FIG. 1, with a view in the direction along the arrow II.

The torsion vibration damper shown in FIGS. 1 and 2 comprise a primary mass 1 and a secondary mass 2, which take reciprocal effect on one another by means, of a spring arrangement 3. The two masses 1, 2, are mounted so as to be capable of rotational movement in relation to one another by means of a sliding bearing 4. The torsion vibration damper further comprises at least one friction device (not shown), by means of which mechanical energy from torsional vibrations, which possibly arise in a drive train comprising this torsion damper, can be drawn from this drive train.

The primary mass 1 comprises essentially a primary plate 5, by means of which forces or a rotational movement are transferred to the spring elements, 3 or to the friction device respectively. In addition to this, the primary mass 1 comprises a starter toothed rim 6, which is located on the primary plate 5 and is connected to it. The starter toothed rim 6 is chosen to be wider than would be necessary to accommodate the forces required at starting. In this situation, the outer diameter d and the depth of the teeth of the starter toothed rim are specified by the motor vehicle manufacturer and by the position of the starter pinion. The height h of the starter toothed rim 6 is selected to be relatively small, so that the spring arrangement 3 and the friction device can be provided radially as far as possible on the outside, in order to be able to develop their effect to best possible advantage. In the present embodiment the width b amounts to 5.8% of the diameter d, and is greater than 1.2 times the height h. In the specific implementation, the starter toothed rim 6 is selected in this case to be so wide that the moment of inertia, required or specified by the motor vehicle manufacturer will be applied by the primary mass 1, consisting of primary plate 5 and starter toothed rim 6. As a result of this, it is possible to do without an additional mass, which would otherwise likewise have to be located on the primary plate.

This arrangement has the further advantage that the teeth are wider than is the case with arrangements according to the prior art, so that a starter pinion can be selected which is narrower in order to achieve the same installation tolerances, or so that, when used with a conventional starter pinion, a greater installation tolerance will be achieved.

The torsion vibration damper according to this embodiment is designed for a motor vehicle with a combustion engine, which features a displacement of less than 3 liters.

1. A torsion vibration damper with two modules (1, 2) mounted on bearings such as to be capable of rotational movement in relation to one another, in which at least one module (1) features a toothed rim (6), characterized in that the toothed rim (6) is designed to be wider than 12 mm.

2. The torsion vibration damper according to claim 1, characterized in that the toothed rim is designed to be wider than 13 mm.

3. The torsion vibration damper according to claim 2, characterized in that than toothed rim (6) is designed to be wider than 14 mm.

4. The torsion vibration damper according to claim 3, characterized in that the toothed rim (6) is designed to be wider than 15 mm.

5. The torsion vibration damper according to claim 4, characterized in that the toothed rim (6) is designed to be wider than 16 mm.

6. The torsion vibration damper according to claim 5, characterized in that the toothed rim (6) is designed to be wider than 17 mm.

7. The torsion vibration damper with two modules (1, 2) mounted on bearings such as to be capable of rotational movement in relation to one another, in which at least one module (1) features a toothed rim (6), characterized in that the ratio of the toothed rim width (b) to the toothed rim height (h) is greater than 1.

8. The torsion vibration damper according to claim 7, characterized in that the ratio of the tooth ed rim width (b) to the toothed rim height (h) is greater than 1.1.

9. The torsion vibration damper according to claim 8, characterized in that the ratio of the toothed rim width (b) to the toothed rim height (h) is greater than 1.2.

10. The torsion vibration damper with two modules (1, 2) mounted on bearings such as to be capable of rotational movement in relation to one another, in which at least one module (1) features a toothed rim (6), characterized in that the ratio of the toothed rim width (b) to the toothed rim diameter (d) is greater than 0.05.

11. The torsion vibration damper according to claim 10, characterized in that the ratio of the toothed rim width (b) to the toothed rim diameter (d) is greater than 0.052.

12. The torsion vibration damper according to claim 11, characterized in that the ratio of the toothed rim width (b) to the toothed rim diameter (d) is greater than 0.053.

13. The torsion vibration damper according to claim 12, characterized in that the ratio of the toothed rim width (b) to the toothed rim diameter (d) is greater than 0.055.

14. The torsion vibration damper according to claim 13, characterized in that the ratio of the toothed rim width (b) to the toothed rim diameter (d) is greater than 0.058.

15. The torsion vibration damper according to claim 1, characterized in that the torsion vibration damper is for a motor vehicle with a displacement of less than 3 liters.

16. The torsion vibration damper according to claim 1, characterized in that the torsion vibration damper is for a motor vehicle with a combustion engine.
